(19) United States
(12) Patent Application Publication
(10) Pub. No.: US 2026/0315296 A1
(43) Pub. Date: Oct. 15, 2026

(54) Control Assembly for Deployment and Retraction of a Fifth Driven Wheel of a Patient Support Apparatus

(71) Applicant: LINET spol. s r.o., Slaný (CZ)

(72) Inventors: Vladimír KOLÁR, Slaný (CZ); Tomas CHLOPCIK, Bohuslavice (CZ)

(73) Assignee: LINET spol. s r.o., Slaný (CZ)

(21) Appl. No.: 19/485,266

(22) PCT Filed: Jun. 3, 2024
(86) PCT No.: PCT/CZ2024/000017

§ 371 Date: Nov. 17, 2025

(30) Foreign Application Priority Data
Jun. 5, 2023 (CZ) PV 2023-225

(51) Int. Cl. A61G 7/08; A61G 7/05

(52) U.S. Cl. CPC A61G 7/08; A61G 7/0528

(57) ABSTRACT

A patient support apparatus for use in healthcare and nursing facilities comprises casters attached to a base frame or undercarriage, driven fifth wheel, and a control assembly for deployment and retraction of the fifth driven wheel. The control assembly can be controlled by pedals of a central caster control mechanism or a servomotor attached to the central caster control mechanism. The position of fifth driven wheel is controlled simultaneously with the casters.

### CROSS-REFERENCE TO RELATED APPLICATIONS

This application, filed under 35 USC 371, is a United States National Stage Application of International Application No. PCT/CZ2024/000017, filed Jun. 3, 2024, which claims priority to CZ Application No. PV 2023-225, filed on Jun. 5, 2023, the disclosures of which are incorporated herein by reference in their entirety.

### BACKGROUND OF THE INVENTION

This invention relates in general to patient support apparatuses in healthcare and nursing facilities having casters attached to a base frame or undercarriage of a patient support apparatuses, and an accessory or fifth driven wheel, and particularly to control assembly for deployment and retraction of such fifth driven wheel. This control assembly can be controlled by pedals of central caster control mechanism or also by a servomotor attached to the central caster control mechanism, the position of fifth driven wheel is thus controlled simultaneously with controlling of casters of patient support apparatus.

Patient support apparatuses used in healthcare and nursery facilities comprise casters which enable movement of such patient support apparatuses from operating room to intensive care units, or between the individual hospital departments and rooms. Such patient support apparatuses being e.g. hospital beds, nursery beds, stretchers, examinational chairs or other suitable apparatuses for use in healthcare facilities will hereinafter be referred to as a bed or patient support apparatus. Majority of such patient support apparatuses comprises additional fifth wheel which is preferably independently driven and controlled.

Healthcare facility beds are typically equipped with caster devices and are designed to be moved from one location to another location or to be otherwise handled inside a room. In contrary, upon reaching a desired location a brake is applied to the casters to maintain the bed at the selected position. Casters can turn around horizontal as well as vertical axis which allows the bed to be rolled and steered between the individual locations. Healthcare facility beds typically have four casters, some beds may be equipped with a fifth wheel. Such fifth wheel is an additional accessory wheel used for easier handling with the bed. The fifth wheel may be positioned under the bed, in the middle of undercarriage, and can be typically actuated and driven separately by its own drive. Very often the fifth wheel is, in parallel, direction wheel and driven wheel supporting easier movement and handling with the bed.

Beds having undercarriage with four casters are equipped usually with at least two casters with assembly to lock such casters in direction of drive. Some beds in prior art are equipped with four separate brake mechanisms and/or steering lock mechanisms and four separate brake pedals or actuating pedals each associated with only one of the four casters. Later, due to safety reasons, a central control mechanism started to be used with healthcare facility beds. At least one actuating or control pedal of the central control mechanism is positioned anywhere on the undercarriage or on any of the casters and controls the brakes of all casters at once. Preferably, the bed is equipped with more than one actuating or control pedal positioned on the undercarriage to control movement, braking or steering lock of the casters from any side of the bed where a caregiver may stand at the given moment.

Typically, central control mechanism has three positions, i.e. the actuating pedal of the central control mechanism can be positioned to a position referred to as:
“braked”—turning of all casters both around horizontal axis and around vertical axis is blocked,
“unbraked”—all casters can freely turn around their horizontal as well as vertical axis, the bed can be freely moved into all directions, and
“ride” or “straight movement direction”—turning of one or two casters around vertical axis is locked in a pre-selected position, other casters can freely turn around horizontal as well as vertical axis.

The above specified central control mechanism can be controlled mechanically, and also electrically. Need to make handling and operation with a bed, when a patient is supported on, easier, a fifth wheel started to be added on the bed undercarriage. The fifth wheel can be also mechanical or equipped with electromotor which actuates and/or brakes the wheel, or deploys and/or retracts the wheel to be used. The fifth wheel with electromotor has own electric control mechanism for engagement and movement of the wheel. In case a healthcare facility bed is equipped with such fifth wheel, the bed controller needs to include an indication component or mechanism stating if the other casters on the bed are in position “braked” or “unbraked” so that a caregiver could safely control the fifth wheel and move the bed safely. This type of solution for handling and moving the bed is not convenient because it requires two completely separated and to each other independent systems to control four casters mounted in the undercarriage of the bed and to control the fifth wheel as well. Such technical solution increases weight of the bed as well as production costs and overall complexity of production.

At present time, a trend to control bed casters in remote manner occurs. This is convenient typically when a bed is equipped with fifth driven wheel. Preferably, central caster control mechanism can control casters in parallel, simultaneously, with deployment and retraction of the fifth driven wheel. The central caster control mechanism is, in presented solution herein, coupled to a new mechanism for deployment and retraction of the fifth driven wheel and enables thus simultaneous controlling of casters and the fifth driven wheel. In addition, as disclosed below, such controlling can be done either mechanically or electrically at once, with no need to indicate which method of controlling was used previously. In majority cases the fifth driven wheels are actuated either only mechanically, or only electrically. No patented solution is recognized by prior art that would disclose central caster control mechanism actuated mechanically and electrically at once, simultaneously, i.e. dually, and, in addition coupled to assembly for deployment and retraction of the fifth driven wheel.

Similar technical solution known in prior art is a patent of the company STRYKER, U.S. Pat. No. 8,701,229B2. This patent discloses a mechanical switch assembly for mechanical or electrical central control mechanism of casters. A healthcare facility bed includes a central control pedal, or central actuating pedal, positioned approximately in the middle of the bed undercarriage. The central control, or actuating, pedal actuates mechanically four casters all at once and operates all casters to all positions, i.e. braked, unbraked and straight movement direction (ride). The central control pedal may be turned around mechanically, and mechanical central control can be switched over by a switch to electrical central control. Change of position of the switch is sensed by a sensor in the mechanical switch. Mechanical central control of casters is configurated in one position of pedal, in the other position of the pedal electric central control of casters is configurated. Such central control mechanism represents a certain progress in central control logic, when a caregiver may select a manner how braking and movement of casters will be controlled and operated. Disadvantage may be recognized in the fact that the caregiver must always finds out if the central control mechanism is activated for mechanical control or electrical control. Should electric central control be activated for operation, the mechanical central control cannot be used unless the control pedal is manually (mechanically) switched over, and vice versa, and switching over needs to be signalled in the bed controller. This embodiment does not disclose any fifth driven wheel being installed on the undercarriage of the patient support apparatus.

Another close prior art is disclosed in another patent of the company STRYKER, U.S. Pat. No. 10,806,653B2. Disclosed patented system uses manual mechanical, as well as electrical central control of casters, however this technical solution is very different from the central dual control system of casters disclosed herein by the applicant. The bed in the above stated patent comprises an undercarriage including an electromotor and a linkage assembly to which an actuating pedal is attached. The actuating, or control, pedal operates mechanical control of the casters, and the electromotor operates electric control of the casters, however, only provided that the actuating pedal of mechanical control of casters is always positioned in the initial neutral position. Should the bed be braked mechanically, and the actuating pedal not be in the initial neutral position, the electric control of casters cannot be engaged, and vice versa. The electric control of casters cannot be used without switching the actuating pedal into the initial neutral position. A caregiver thus keeps physical checking all the time what the position of the actuating pedal is to select a manner of caster controlling.

Another patented solution known in prior art is disclosed in the patent of the company Huntleigh Technology Ltd., U.S. Pat. No. 11,311,439 (B2), relating to deployment of the fifth driven wheel. This patent discloses a fifth driven wheel assembly, or a pair of driven wheels, located between the caster undercarriage frame. Disclosed lifting mechanism for deployment of the fifth driven wheel, or wheels, comprises a lift block and a lever arm to deploy and retract the fifth driven wheel. The wheel is retracted when the lift block moves in relation toward the lever arm and the lever arm moves upward along angularly set surface. The lifting mechanism comprises an arranged surface with several pins which engage a fork slot on the pivotable shaft. This method of deployment and retraction of the fifth driven wheel is mechanical using a pedal. However, as such mechanism is large and heavy due to special structure assembly it is not coupled to central caster control mechanism and braking of other casters on the bed needs to be done separately. In addition, this mechanism cannot be controlled electrically due to its very complex structure. To control deployment of the fifth driven wheel, a separate pedal needs to be installed which can be positioned only in the middle position on the undercarriage. Therefore, it is not possible to control deployment and retraction of the fifth driven wheel from anywhere on the bed, as well as not by using any electrical assembly. Disclosed mechanism of controlling the fifth driven wheel is too heavy and structurally very complex, also financially and technically demanding for production.

Due to the above stated reasons and disclosed disadvantages, it is desired to develop structurally simpler, faster and safer central control mechanism of casters which may be dually utilized for mechanical central control of casters as well as electrical central control of casters without any physical check or without any need to signal or indicate which control manner is activated at present and thus available for operation. A caregiver does not have to consider which control manner to select and, in parallel, as the assembly for deployment and retraction of the fifth driven wheel is coupled to central caster control mechanism, it is apparent in which position the fifth driven wheel needs to be. In addition, safety handling with the bed increases.

### SUMMARY OF THE INVENTION

The above-mentioned substantial insufficiencies of the existing known technical solutions are solved by disclosed technical solution herein, relating to patient support apparatuses in healthcare facilities, such as hospital beds, nursery beds, stretchers, medical examination chairs and any other suitable apparatuses for use in healthcare facilities, hereinafter be referred to as a bed or patient support apparatus, having a bed undercarriage with central dual control mechanism of casters and a fifth driven wheel.

A new and innovative caster device assembly is disclosed in the international patent application WO 2022068978 filed by the same applicant, which is thereby included herein in its entirety, relating to a triple cam comprising three different cams that allow controlling of a caster using much less force than needs to be developed to control the existing conventional casters. A new and innovative caster device assembly is also disclosed in the international patent application WO 2021223782 filed by the same applicant, which is thereby included herein in its entirety, relating to a caster comprising a two-way band brake.

An undercarriage having dual control mechanism of casters is disclosed in the application filed by the same applicant under title “Patient Support Apparatus Having Central Dual Control System of Casters”, published as WO 2023222146, relating to central caster control mechanism. This control mechanism enables to control all positions of central control caster mechanism dually in parallel using specially assembled servomotor. Dual control means that casters can be controlled manually by pedals, as well as electrically by controller located on the side rail or hanging on the side rail. The controller controls the servomotor coupled to the central caster control mechanism without any need to signal or indicate in which positions the control pedals of casters actually are positioned. The disclosed solution therefore removes selective control of casters when casters can be controlled either only electrically, or only mechanically, and the patient support apparatus needs always to indicate for a caregiver which control method is actuated. Also, this patent application is thereby included herein in its entirety.

The technical solution disclosed herein this application describes, preferably, using of both types of controlling of casters, i.e. manual and electrical, independently on each other, without need to indicate or signal which control method is actuated and without need to change position of the pedal of central caster control mechanism into neutral, intermediate, position. The control motor is firmly attached to the linkage rod of the central caster control mechanism to control the casters by the pedal of central caster control mechanism, as well as simultaneously by the motor. The disclosed technical solution for controlling of casters is thus fully dual as upon mechanical control of casters the motor is rearranged inside which is possible due to special innovative internal arrangement that develops minimum resistance. In the contrary, upon electrical control of casters, electric power is transmitted onto the linkage rod of central caster control mechanism, which rearranges position of the pedal of central control, or of the control shaft of casters which, preferably, can substitute separate control pedals of the individual casters.

The motor, which is preferably servomotor, is designed to be sufficiently forceful when being activated, and on contrary when deactivated to move the internal servomotor assembly with the smallest mechanical resistance. Such designed servomotor allows dual control of casters.

The servomotor comprises a cogwheel and a pinion. The combination of the cogwheel and the pinion located in the servomotor enables dual control of casters, it means to control all casters mechanically or electrically regardless the position of the actuating pedal of the central control mechanism of casters. Toothed wheel, it means the cogwheel and the pinion move in relation to a rack which comprises rack protrusions on the bottom side of the rack by which the servomotor is fixed to the linkage rod of the central control mechanism of casters. Internal arrangement or configuration of the servomotor may use also another type of gearing as for example chain gearing or cogged/toothed belt etc. The embodiment using configuration of the cogwheel and the pinion is preferably the most suitable and the most faultless in comparison with other types of gearing.

The servomotor further comprises a position sensor that senses position of the cogged/toothed wheels, it means the position of the cogwheel and the pinion. The position sensor comprises two mechanical micro switches. Micro switches have two positions—closed and opened. Micro switches transmit information about four positions whereas for dual control it is necessary to have information about three basic positions—braked, unbraked and ride (straight movement direction). The intermediate position may be preferably used as the fourth position, it means that the servomotor is placed in the indefinite position and is not placed in any of the defined positions—braked, unbraked and ride (straight movement direction). Also, other types of position sensors may be used such as optic sensors, magnetic sensors, Hall sensor etc.

Technical solution described herein this application discloses a patient support apparatus comprising a patient support deck which is arranged to support a patient, an upper frame of a patient support apparatus, a lifting mechanism, a bottom frame of a patient support apparatus, i.e. an undercarriage, casters pin-attached to the undercarriage, a pedal of central caster control mechanism, and a fifth driven wheel. The pedal of central caster control mechanism controls always, either, two casters coupled together by a control shaft with hexagonal cross section, or all four casters by means of a linkage rod coupling both control shafts with hexagonal cross section. Casters are controlled mechanically by using the pedal of central caster control mechanism being positioned into the position of “ride”, “braked” or “unbraked”.

The central, dual, caster control mechanism with specially arranged servomotor as stated and disclosed above was developed and invented by the same applicant presenting the solution disclosed herein, therefore the applicant innovatively developed system for easy deployment and retraction of the fifth driven wheel. Innovative mechanism, or assembly, for deployment and retraction of the fifth driven wheel uses the above disclosed servomotor to deploy and retract the fifth driven wheel as needed.

The fifth driven wheel assembly comprises a suspension assembly which is attached to the undercarriage frame of casters. The suspension assembly comprises a lever of a cam which is coupled, at least on one end, to a linkage rod of the central caster control mechanism, and on the opposite end the lever is attached to the frame of the suspension assembly with cam. At least one end of the cam is coupled to the lever at point of axis of lever with suspension assembly. The cam extends on the other end into a shape of letter T. The T-shaped cam comprises at each its T-shaped end a protrusion to provide two essential positions of the fifth driven wheel. These final protrusions on the cam are in contact with a rocker pulley, which moves the fifth driven wheel. The cam is attached to the rocker pulley at one end. The rocker is attached to the pulley and also to a spring element, which is coupled, at the other end, to the linkage rod of the central caster control mechanism by means of a connecting pin. The rocker is, opposite the pulley at the other end, coupled to suspension assembly of the fifth driven wheel at the point of axis of rocker with the driven wheel. The fifth driven wheel is attached to the axis of rocker made by a tube by using of two arms. This fifth driven wheel is deployed and retracted by using of at least one suspension assembly attached to the undercarriage frame, wherein at least one suspension assembly comprises at least one lever, which is, at one end, pivotably attached to the linkage rod of the central caster control mechanism by connecting pin, and at the other end, the lever is attached to axis of lever of cam at one edge of the suspension assembly, and to the cam which is attached on the other side to rocker pulley attached to axis of rocker, wherein attached to the suspension assembly at the point of axis of rocker. Opposite the rocker pulley, the rocker is attached to the spring element, which is on the other side attached to the linkage rod of the central caster control mechanism to which a servomotor for dual control, manual or electrical, of the individual positions of casters and deployment and retraction of the fifth driven wheel is attached to.

Such assembly of the fifth driven wheel comprising the lever attached to the central caster control mechanism, the T-shaped cam attached to the rocker to which the fifth driven wheel is coupled to enables a caregiver to control the fifth driven wheel either manually using the pedals of the central caster control mechanism, or electrically by motor controller which controls positions of the central caster control mechanism in case the caregiver decides to control the bed electrically by controller on the bed. The controller can be integrated in the controllers located on side rails or headboard or footboard of the patient support apparatus, however controller can be independent controller hung on any part of the patient support apparatus. The controller for controlling casters as well as the fifth driven wheel can be remote, connected with control unit or master controller on the bed wirelessly, using e.g. Bluetooth, wi-fi or any other known wireless system.

### DESCRIPTION OF DRAWINGS

Various advantages of this invention will become apparent to those skilled in the art from the following detailed description of the preferred embodiments when read in light of the accompanying drawings:

FIG. 1 shows schematic view of a patient support apparatus with fixing of fifth driven wheel,

FIG. 2 shows schematic view of a dual control mechanism of casters using servomotor,

FIG. 3 shows schematic view of a dual control mechanism of casters with servomotor positioned on the linkage rod of casters,

FIG. 4a shows side detail of fixing of the fifth driven wheel in the “ride” position,

FIG. 4b shows kinematic view of the fifth driven wheel in the “ride” position,

FIG. 5a shows side detail of fixing of the fifth driven wheel in the “neutral” position,

FIG. 5b shows kinematic view of the fifth driven wheel in the “neutral” position,

FIG. 6a shows side detail of fixing of the fifth driven wheel in the “braked” position,

FIG. 6b shows kinematic view of the fifth driven wheel in the “braked” position, and

FIG. 7 shows detailed top view of fixing of the fifth driven wheel to mechanism for changing position by using central caster control mechanism.

### EXEMPLARY EMBODIMENTS OF THE INVENTION

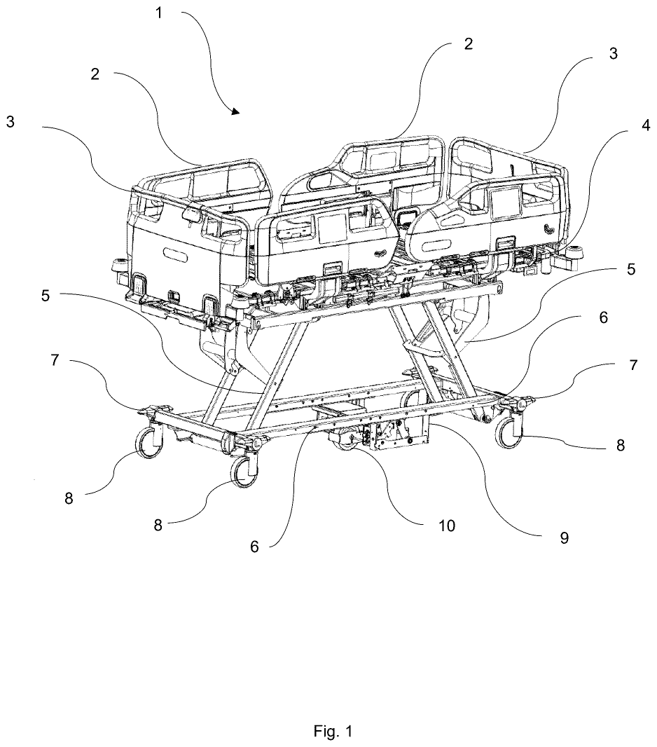

Patient support apparatuses in healthcare facilities, such as hospital beds, nursery beds, stretchers, medical examination chairs and any other suitable apparatuses for use in healthcare facilities (hereinafter as patient support apparatus 1) typically comprises undercarriage with casters to move a patient easily to another place. FIG. 1 shows a patient support apparatus 1 comprising a frame 4 of patient support deck to which side rails 2 and headboard/footboard 3 are attached to. These side rails 2 and headboard /footboard 3 secure safety of a patient lying on the patient support apparatus 1. A lifting mechanism 5 is attached to the bottom side of the frame 4 of patient support deck, which in this FIG. 1 is a scissor lifting mechanism (in another embodiments other types of lifting mechanisms can be used such as electric telescopic columns or hydraulic lifting mechanisms etc.). On the other side, the lifting mechanism 5 is attached to an undercarriage frame 6, casters 8 are positioned on the bottom side of the undercarriage frame 6. The casters 8 are positioned in edges of the undercarriage frame 6. Casters 8 are controlled by control pedals 7 of casters 8, which are positioned above casters 8 and are mutually interconnected to allow controlling of all casters 8 from any side of the patient support apparatus 1. Such mutual interconnection of controlling assemblies of casters is known as central caster control mechanism. The FIG. 1 also shows a fifth driven wheel 10, which is attached to the undercarriage frame 6 of casters 8 by means of a suspension assembly 9. The suspension assembly 9 comprises a metal frame, which can be removable and be thus an accessory optional equipment of a patient support apparatus 1, but can be also permanently integrated in the undercarriage frame 6 of casters 8. Two types of fifth driven wheels 10 can be coupled to this suspension assembly 9 attached to the bottom side of the undercarriage frame 6: a fifth wheel without any drive or a fifth driven wheel with motor. The FIG. 1 shows the fifth driven wheel 10 whose actuating mechanism is coupled to a linkage rod 12 of a control pedal 7 of casters 8. The fifth driven wheel 10 is driven by electric motor which is located directly inside the fifth driven wheel 10. The fifth driven wheel 10 is designed as an additional module to the undercarriage frame 6.

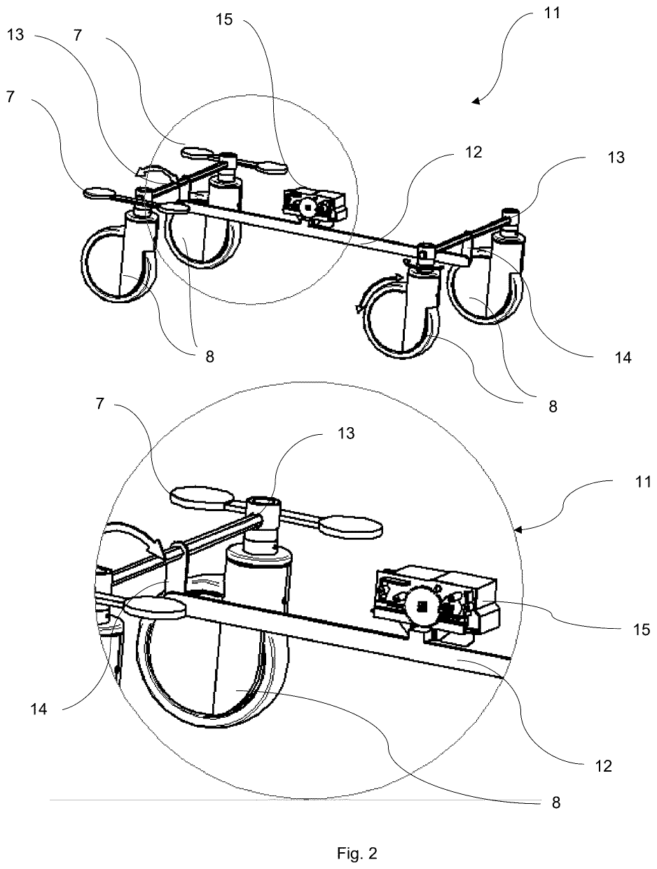

The FIG. 2 shows a dual control mechanism 11 of casters 8 comprising a special servomotor 15, which enables to control all positions of casters 8 dually, i.e. mechanically using control pedals 7 of casters 8 interconnected by a linkage rod 12 of the central control mechanism, and also electrically using electric dual servomotor 15. Functions of servomotor 15 are controlled remotely by remote controller (not shown), however such remote controller can be wired or wireless connected to the servomotor 15 and it can be located either on the side rail of a patient support apparatus, or any of the boards—headboard or footboard, or may be hung up on any part of the support deck or side rail. This FIG. 2 shows that casters 8 are mutually interconnected by connecting shaft with 13 with hexagonal cross section, at least with one pair of casters 8, and is attached to control pedals 7 controlling the individual positions of casters 8. The control shaft 13 of casters 8 is attached to another pair of casters 8 via connecting member 14 and linkage rod 12 of central control mechanism, and these casters 8 are again coupled by control shaft 13 so that at least one control pedal 7 controls all casters 8. Special servomotor 15 is attached to the linkage rod 12 of central caster control mechanism which enables dual controlling. The entire mechanism of dual control of casters is disclosed in the patent application published as WO 2023222146, filed by the same applicant as herein. This application is thereby included hereto in its entirety.

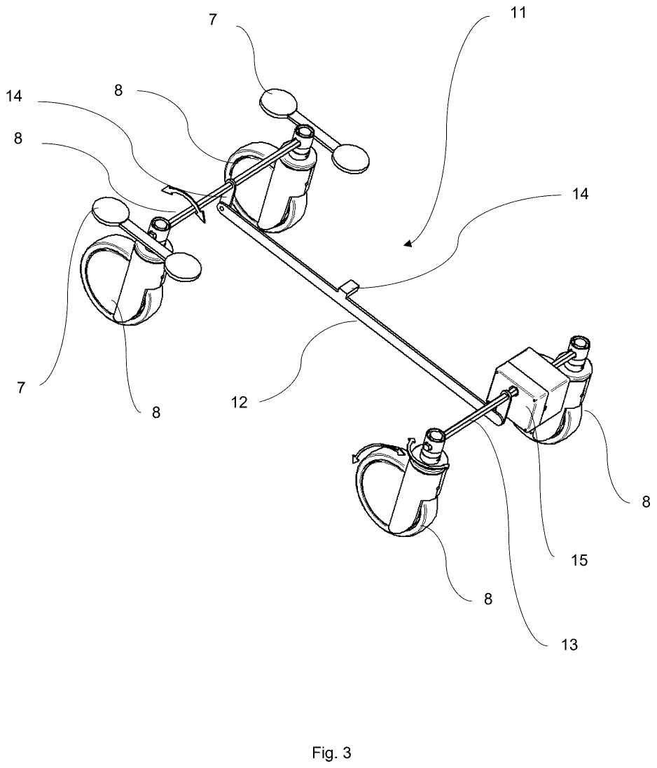

The FIG. 3 shows schematic view of casters 8 and their arrangement. The FIG. 3 shows another embodiment where a different type of servomotor 15 is attached for dual control of casters 8. Dual control mechanism is disclosed in the patent application published as WO 2023222146, filed by the same applicant as herein. This application is thereby included hereto in its entirety. The FIG. 3 shows four casters 8, whereas at least two pairs of casters 8 are mutually interconnected by control shaft 13. Both pairs of casters 8 are mutually interconnected via connecting member 14 and a linkage rod 12 of central control mechanism. FIG. 3 shows electric servomotor 15 of dual control mechanism located at least on one control shaft 13 of at least one pair of casters 8 to that this servomotor 15 controls the individual positions of control pedals 7 of casters 8. Change of position of the control pedals 7 via control shaft 13 controls also the position of the linkage rod 12, which then controls the control shaft 13 of the other pair of the casters 8, therefore also control pedals 7 as well as positions of casters 8 on the other side are controlled.

Both above-mentioned figures, which are illustrative, show only two pairs of control pedals 7 of casters 8. However, patient support apparatuses in healthcare facilities comprises, preferably, more control pedals 7 to control casters 8, typically, there is an control pedal 7 with each caster 8, as visible in FIG. 1 showing a patient support apparatus 1 comprising fifth driven wheel 10. FIG. 1 does not show arrangement of servomotor 15 for dual control of casters 8, but it is apparent from the aforesaid that electric motor, or servomotor 15, for dual control can be located anywhere on the undercarriage 6 of casters 8. The servomotor 15 can be located either on the linkage rod 12 of the central control mechanism thus controlling all casters 8 including the fifth driven wheel 10, or anywhere on the side to be attached at least to one pair of casters 8, it means attached to the control shaft 13 of at least one pair of casters 8, whereas the control shaft 13 is interconnected with the other control shaft 13 of the other pair of casters 8 via linkage rod 12 of the central caster control mechanism by which other casters 8 and also the fifth driven wheel are controlled.

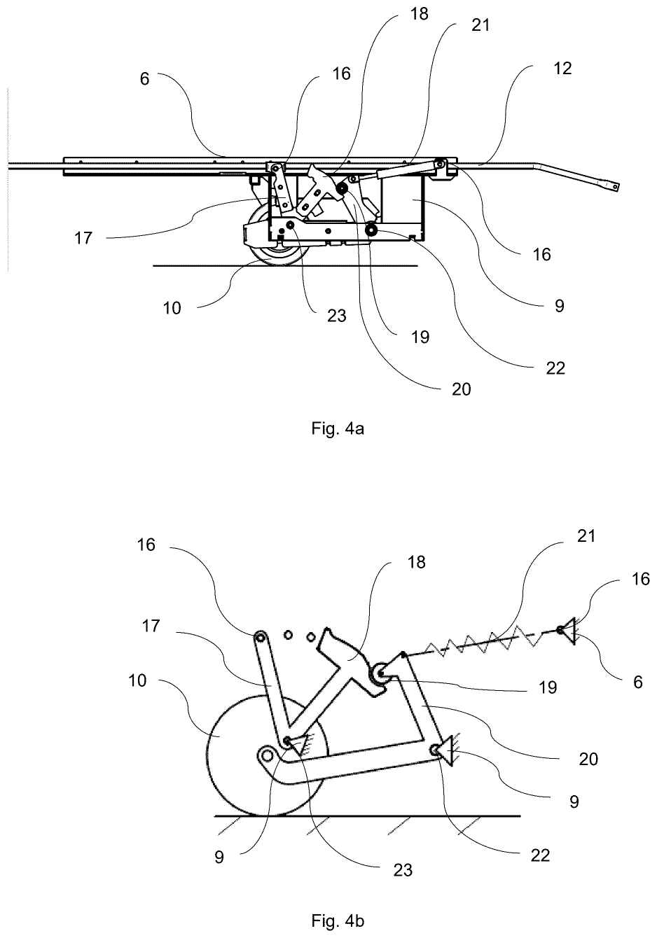

The FIG. 4a shows a position of a fifth driven wheel 10 in the position “ride”. The FIG. 4a shows side view of the fifth driven wheel 10, which is attached to an undercarriage frame 6 by means of a suspension assembly 9 of the fifth driven wheel 10. The fifth driven wheel 10 is shown in the position “ride”, which means that the fifth driven wheel 10 is deployed and in contact with the floor. FIG. 4a shows a part of the undercarriage frame 6 with a linkage rod 12 of the central caster control system. The suspension assembly 9 of the fifth driven wheel 10 is attached to the undercarriage frame 6, the suspension assembly 9 comprising a metal frame attached to the undercarriage frame 6 of the patient support apparatus 1. It is apparent in this view that a lever 17 of a cam 18 is attached to the linkage rod 12 of the central caster control mechanism by a connecting pin 16 at one end. At the other end, the lever 17 is coupled with an axis of lever 23 and attached to the bottom side of the suspension assembly 9. At the point of axis of lever 23, the lever 17 is attached to the cam 18, which has T-shaped end on the other side, the upper edge of T-shape is finished as wave or a part of an arc or semi-circle, and each end comprises protrusions for locking position on a pulley 19 of a rocker 20. The rocker 20 comprises the pulley 19 at one end, and opposite the pulley 19 the rocker 20 is located having a spring element 21, which is on the other end attached to the linkage rod 12 of the central caster control mechanism. The spring element 21 is a gas spring, yet in another embodiment it can be e.g. steel spring attached to the rocker 20 at least at one end. The spring element 21 pushes the rocker 20 of the fifth driven wheel 10 so that the fifth driven wheel 10 moved in direction away from the undercarriage frame 6 in case the control pedals 7 are positioned in the position “ride”. Optionally, power generated by servomotor 15 of dual control mechanism (disclosed above) can be transferred to the linkage rod 12 by which the position of casters 8 as well as the fifth driven wheel 10 can be controlled and positioned electrically. The rocker 20 comprises, at least at one end, the pulley 19, which is preferably in contact with the cam 18, and on the other end the rocker 20 is attached by using of connecting pin 16 to the frame of the suspension assembly 9 at the point of axis of rocker 22 with the fifth driven wheel 10. The fifth driven wheel 10 is attached to the axis of rocker 22, the fifth driven wheel 10 is located in the gap in the middle of undercarriage frame 6 of casters 8.

The FIG. 4b shows kinematic view of the position of a fifth driven wheel 10 in the position “ride”. The FIG. 4b shows a lever 17 attached to a linkage rod 12 (not shown) by connecting pin 16, and at the other end to a cam 18. A rocker 20 is attached by a spring element 21, e.g. a gas spring. The spring element 21 is attached at the other end to un undercarriage frame 6. This figure shows apparently the mutual position of the cam 18 and the pulley 19, which impacts the position of the rocker 20.

The rocker 20 is pivotably attached to the suspension assembly 9 at the point of axis of rocker 22. In this position, the pulley 19 of the rocker 20 does not touch the cam 18 due to which the spring element 21 pushes with all its strength the fifth driven wheel 10 to the floor.

The linkage rod 12 is attached to control pedals 7 of casters 8 and the servomotor 15 for dual control of casters. By changing a position of the linkage rod 12 caused manually by control pedal 7 of casters 8 or by servomotor 15, the position of the fifth driven wheel 10 changes.

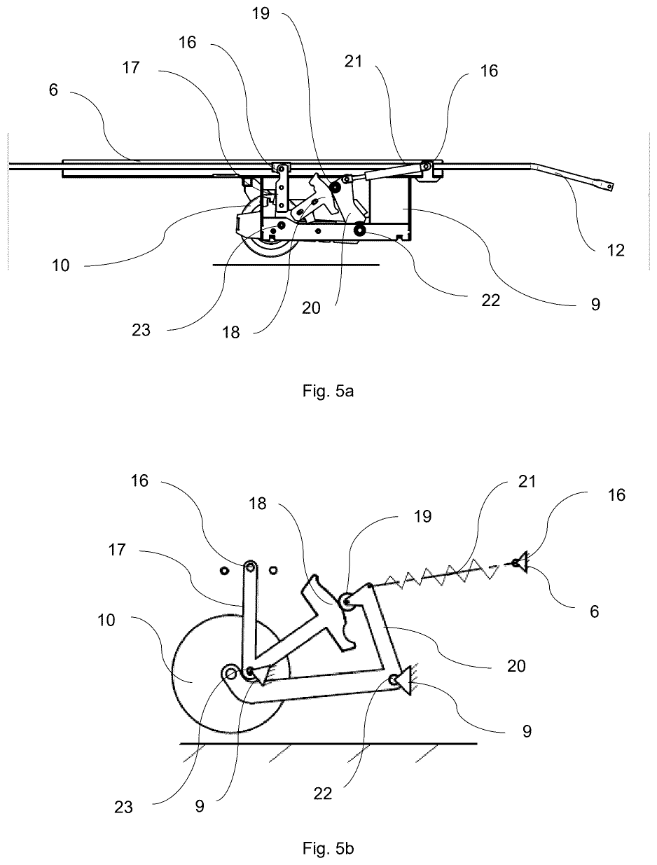

The FIG. 5a shows a “neutral” position when a fifth driven wheel 10 is retracted above the floor. The FIG. 5a shows a suspension assembly 9 of the fifth driven wheel 10. The suspension assembly 9 of the fifth driven wheel 10 is attached to the undercarriage frame 6 of casters 8. The same as with the previous figure, FIG. 5a shows that a lever 17 is at one end attached to a linkage rod 12 of the central caster control mechanism (not shown) by connecting pin 16. At the other end of the lever, the lever 17 is attached to the suspension assembly 9 in a point of axis of lever 23. At this point the lever 17 extends to a cam 18. At the bottom side of the suspension assembly 9, where the axis of lever 23 is, a visible point of axis of rocker 22 of the fifth driven wheel 10 is located, at the other end, or opposite the point of axis of lever 23. The rocker 20 is attached at this point of axis of the rocker 22, which comprises a pulley 19 of the rocker 20 at the other end, which is in contact with the cam 18. The rocker 20 is attached to a spring element 21, which is a gas spring. The spring element 21 is at the other end attached to a linkage rod 12 of the central caster control mechanism by connecting pin 16. The spring element 21 in this case helps to keep the fifth driven wheel 10 above the floor in the neutral position so that the other casters could be controlled, and the patient support apparatus could be moved. Change of position of the spring element 21 is supported by cam 18, which is in contact with the pulley 19 of the rocker 20, which impacts position of the fifth driven wheel 10.

The FIG. 5b shows kinematic view of the above-described neutral position of the fifth driven wheel 10. This FIG. 5b shows a suspension assembly 9 attached to a part of an undercarriage frame 6 to obviously and clearly disclose simplicity of the assembly for deployment and retraction of the fifth driven wheel 10, which can be controlled manually as well as electrically, i.e. dually by means of a servomotor 15 (not shown) developed by the applicant as well.

The FIG. 5b shows a lever 17 attached to a linkage rod 12 (not shown) by connecting pin 16, and at the other end to a cam 18. A rocker 20 is attached by a spring element 21, e.g. a gas spring, at one end. The spring element 21 is attached at the other end to un undercarriage frame 6. This figure shows apparently the mutual position of the cam 18 and the pulley 19, which impacts the position of the rocker 20.

The rocker 20 is pivotably attached to the suspension assembly 9 at the point of axis of rocker 22. In this neutral position, the pulley 19 of the rocker 20 touches the cam 18 due to which the spring element 21 is pushed and the fifth driven wheel 10 retracted from the floor.

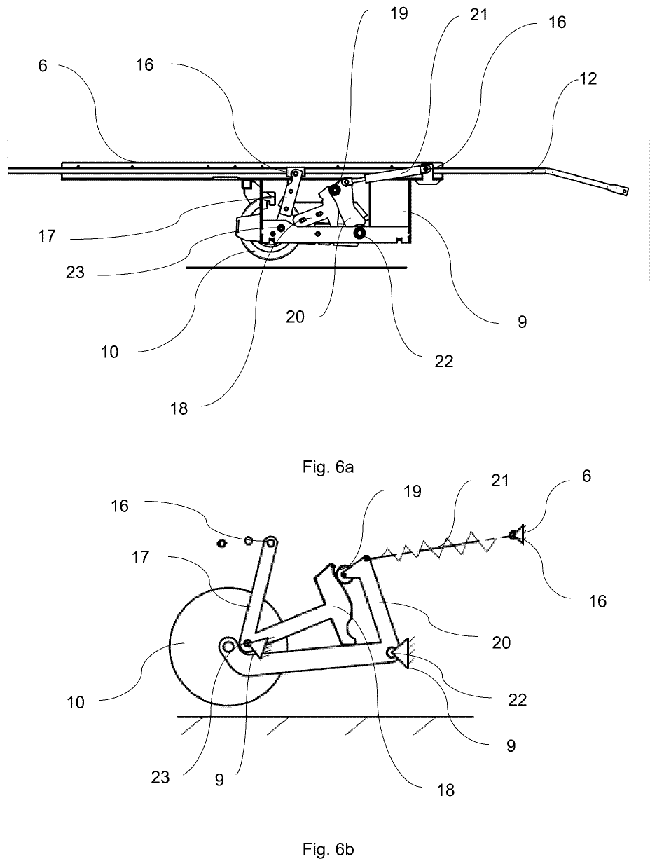

The FIG. 6a shows a position of a fifth driven wheel 10 in the position “braked” when the fifth driven wheel 10 is in maximum retracted elevated position above the floor. The FIG. 6a shows side view of the fifth driven wheel 10, which is attached to an undercarriage frame 6 by means of a suspension assembly 9 of the fifth driven wheel 10. It is apparent in this view that a lever 17 of a cam 18 is attached to the linkage rod 12 of the central caster control mechanism by a connecting pin 16 at one end. At the other end, the lever 17 is coupled with an axis of lever 23 and attached to the bottom side of the suspension assembly 9. The cam 18, which is at one end attached to the axis of lever 23, extends, at the opposite end, to a shape of letter T, whereas at this end the cam 18 attaches a pulley 19 of the rocker 20. The rocker 20 is attached, next to the pulley 19, to a spring element 21, which is attached to the linkage rod 12 of central caster control mechanism (not shown) at the opposite end by connecting pin 16. Opposite the pulley 19 the rocker 20 is attached to the suspension assembly 9 at the point of axis of the rocker 22. The FIG. 6a shows that position of the cam 18 is impacted by the lever 17, which is controlled by means of the linkage rod 12 of the central caster control mechanism. The figure shows that at least one top of the cam 18 is in contact with the pulley 19 of the rocker 20, which is in this case raised up into the elevated position, when the rocker 20 is retrieved by spring element 21 whose opposite end is attached to the linkage rod 12 thus its position is controlled. The FIG. 6a shows that in case the casters 8 are braked, the fifth driven wheel 10 is in the retracted (elevated) position. Also, this position can be controlled either mechanically by control pedals 7 of the central control mechanism, as well as electrically by servomotor 15 using the remote controller located on the side rail 2 or a headboard/footboard 3, or hung up on any part of the patient support apparatus 1 (not shown).

The FIG. 6b shows kinematic view of the above-described position “braked” of the fifth driven wheel 10. This FIG. 6b shows that casters 8 are braked and the fifth driven wheel 10 retracted in the elevated position.

The FIG. 6b shows a lever 17 attached to a linkage rod 12 (not shown) by connecting pin 16, and at the other end to a cam 18. A rocker 20 is attached by a spring element 21, e.g. a gas spring, at one end. The spring element 21 is attached at the other end to un undercarriage frame 6. This figure shows apparently the mutual position of the cam 18 and the pulley 19, which impacts the position of the rocker 20.

The rocker 20 is pivotably attached to the suspension assembly 9 at the point of axis of rocker 22. In this position “braked”, the pulley 19 of the rocker 20 touches the cam 18 due to which the spring element 21 is pushed and the fifth driven wheel 10 retracted from the floor.

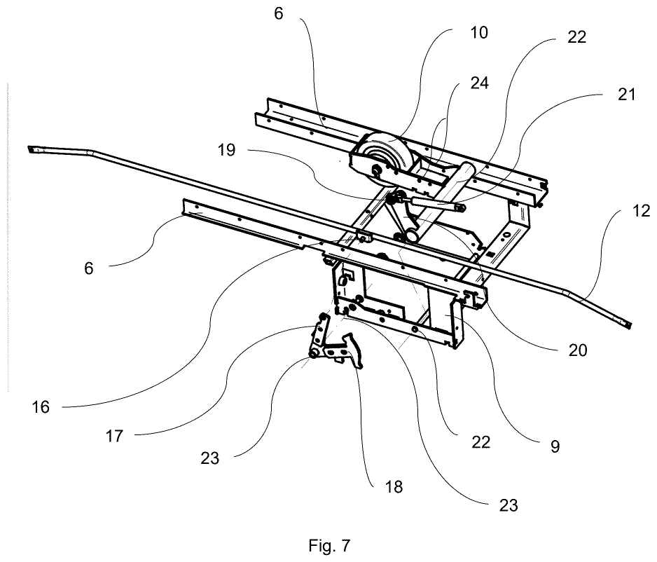

The FIG. 7 shows exploded drawing of the entire lifting mechanism of the fifth driven wheel 10. The drawing shows parts of profile of the undercarriage frame 6 of casters 8 (not shown). These parts undercarriage frame 6 are mutually interconnected by metal profiles to attach bearing assembly of the fifth driven wheel 10 together with deploying and retracting mechanism of fifth driven wheel 10. The fifth driven wheel 10 is located between the profiles of the undercarriage frame 6 and moves pivotably on the axis of the rocker 22 of the fifth driven wheel 10. The deploying and retracting mechanism of the fifth driven wheel 10 is attached to at least one profile of the undercarriage frame 6 to which a suspension assembly 9 is attached. The suspension assembly 9 is shown on the front part of the undercarriage frame 6, however can be located to both parts of profile of the undercarriage frame 6, or opposite each other to both profiles of the undercarriage frame 6. The figure obviously shows that only one part of the suspension assembly 9 comprises a lever 17 with a cam 18. The can 18 is shown exploded outside the suspension assembly 9, however it is apparent from the previous figures that this component is located and attached to the suspension assembly 9. At least on end of the lever 17 is attached via a connecting pin 16 to a linkage rod 12 of the central caster control mechanism, and at the other end is attached to a point of axis of lever 23 with cam 18. At this point, the cam 18 and the lever 17 are coupled to the suspension assembly 9, as previously shown. At least one end of the cam 18 is at one end in contact with a pulley 19 of the rocker 20, which is attached to the suspension assembly 9 at one side. On the same side where the pulley 19 is located also the rocker 20 is located and attached to a spring element 21. The spring element 21 is at one end attached to the rocker 20 and on the other end to the linkage rod 12 of the central caster control mechanism of casters 8 and to the fifth driven wheel 10.

The linkage rod 12 of the central caster control mechanism is shown separately above the profile of the undercarriage frame 6. The figure shows that the linkage rod 12 comprises a pivotable pin, another pin is a connecting pin 16, by which the spring element 21 is attached (not shown).

The cam 18 extends at the other end to a shape of letter T, whereas at this end, the cam 18 is in contact with the pulley 19 of the rocker 20. The rocker 20 is located on the arm of pivotable axis of the rocker 22, on which also bearing arm with the fifth driven wheel 10 is located. A suspension arm 24 of the fifth driven wheel 10 is attached, at the opposite end of the suspension assembly 9, via the rocker 20 to the axis of the rocker 22. The fifth driven wheel 10 moves along the axis of the rocker 22 up and down according to position of the control pedal 7 of the central caster control mechanism. Changes of positions of the fifth driven wheel 10 are caused by mechanically using control pedals 7, as well as electrically by special servomotor 15 for dual control of casters 8, which controls by actuating a controller on a display or on a hung up or remote controller located anywhere on side rails 2 or headboard/footboard 3 or frame 4 of the patient support deck of the patient support apparatus 1.

### LIST OF REFERENCES

1) Patient support apparatus
2) Side rails
3) Headboard/footboard
4) Frame (of patient support deck)
5) Lifting mechanism (scissor type)
6) Undercarriage frame (of casters)
7) Control pedal(s) of casters
8) Casters
9) Suspension assembly
10) Fifth driven wheel
11) Dual control mechanism
12) Linkage rod (of central caster control mechanism)
13) Control shaft
14) Connecting member
15) Servomotor (of dual control)
16) Connecting pin
17) Lever
18) Cam
19) Pulley (of rocker)
20) Rocker
21) Spring element (gas spring)
22) Axis of rocker with driven wheel
23) Axis of lever with cam
24) Suspension arms of fifth driven wheel

1. A control assembly for deployment and retraction of a fifth driven wheel comprises a central caster central mechanism located in an undercarriage frame further comprising two pairs of casters with at least one control pedal, wherein each pair of casters is mutually Interconnected by a control shaft, wherein both control shafts are mutually interconnected via a connecting member with a linkage rod of the central caster control mechanism, wherein a servomotor is located on the linkage rod, wherein at least one suspension assembly is attached to the undercarriage frame, wherein the at least one suspension assembly comprises at least one lever, which is, at one end, attached to the linkage rod of the central caster control mechanism by a pivotable pin, and at another end, is attached to an axis of a cam at one edge of the suspension assembly, and to the cam, which is at another end in contact with a pulley of a rocker, which is, at one end, attached to an axis of the rocker, wherein the rocker is attached to a suspension assembly at the point of the axis of the rocker, another end of the rocker located opposite the pulley is attached to a spring element, which is, at the another end, attached to the linkage rod of the central caster control mechanism to which the servomotor is attached, wherein by moving the linkage rod in relation to the suspension assembly, the servomotor dually controls all positions of the casters (8) and deploys the fifth driven wheel manually or electrically.

2. The control assembly for deployment and retraction of a fifth driven wheel according to claim 1, wherein the cam has a T-shape, at one side, with hook-shaped protrusions, and an upper side shaped as arc of semi-circle.

3. (canceled)

4. (canceled)

5. (canceled)

6. (canceled)

7. The control assembly for deployment and retraction of a fifth driven wheel according to claim 1, wherein the spring element is a gas spring.

8. The control assembly for deployment and retraction at a fifth driven wheel according to claim 1, wherein the rocker comprises a flat surface to which the pulley is attached to at one side, and on another side the axis of the rocker protrudes in the form of a bearing tube of the fifth driven wheel.
